(19) United States
(12) Patent Application Publication
(10) Pub. No.: US 2003/0061073 A1
(43) Pub. Date: Mar. 27, 2003

(54) Method and system for displaying patient information

(76) Inventors: Khiang Seow, Madison, WI (US); Carl Dvorak, Madison, WI (US); Christopher Alban, Madison, WI (US); Sek Cheong, Madison, WI (US); Brad Eichhorst, Verona, WI (US); Kapil Gupta, Madison, WI (US); Manish Kumar, Madison, WI (US); Indu Prakash, Madison, WI (US); Brent Warner, Oregon, WI (US)

Correspondence Address: Randall G. Rueth, MARSHALL, GERSTEIN & BORUN, Sears Tower, 233 S. Wacker Drive, Suite 6300, Chicago, IL, 60606-6357, US

(21) Appl. No.: 10/209,513

(22) Filed: Jul. 31, 2002

Related U.S. Application Data
(60) Provisional application No. 60/309,412, filed on Aug. 1, 2001.

(51) Int. Cl. G06F 17/60; G06F 9/44

(52) U.S. Cl. 705/3

(57) ABSTRACT

A method and system for displaying patient and administrative information in a health care environment comprising the steps of obtaining records, obtaining rules governing the display of information, applying the rules to the records to determine what information is to be displayed, and displaying the information gathered and processed in accordance with the rules. The system also allows users to select records and reports, altering the displayed information while maintaining compliance with the rules.

### CROSS-REFERENCE TO RELATED APPLICATIONS

This application claims priority to U.S. Provisional Application Serial No. 60/309,412, entitled “Method for Displaying Patient Information,” filed Aug. 1, 2001 (attorney docket number 29794/37610), which disclosure is expressly incorporated by reference.

### TECHNICAL FIELD

The present patent relates generally to workflow management in a health care environment; and specifically to a method and system for displaying information from an electronic medical record (EMR) system, with or without user authentication, in a health care facility.

### BACKGROUND

To facilitate the dissemination of information useful to clinicians, hospitals have developed simple methods for making non-identifiable patient information easily available to nurses and others in a unit. A “bed board” or “grease board” displays information about each patient in a unit (such as bed number, status indicator, and attending provider), and can potentially indicate the members of each patient's treatment team. Flags and colored dials in patient charts indicate that new information such as results, notes, or orders have been added.

While these systems make it simple for clinicians to see information relevant to their workflows, they require manual updates from those responsible for patient care. Clinicians must both document new information in a patient's chart and flag the new information in the chart or on the bed board. This creates a redundant step in clinicians' workflows, and introduces the possibility that a clinician could forget to flag the new data he or she documented.

Additionally, clinicians only have access to the information maintained in their physical location. For example, identifying patients awaiting transfer from one treatment unit to another will often require contacting one or more other units.

Several attempts have been made to simplify the processes described above through a computer-based system that automatically displays updated patient information.

Some solutions implement an electronic display of patient data as stand-alone systems, which are not linked to EMR systems and do not provide the streamlined workflows that a solution linked to an EMR system would provide. Other solutions include an online patient list, or census, and other summary data as part of an EMR system workflow. While these solutions improve the administration process, they sacrifice the convenience of the non-electronic system. Because patient confidentiality is a major concern in a clinical environment, these EMR solutions implement a user authentication system to verify that it is appropriate for the user to view the patient data.

While user authentication maintains security, it is comparatively very time-consuming. For example, users must take the time to access the system by validating their identity through a password or some other means, rather than glancing at a nursing station to see if any charts have a “new notes” flag. It is possible that a user might log in to the system and find nothing that requires his or her attention. If users want easy, real-time access to alerts and notifications they need to leave their sessions open, creating a potential security breach.

An earlier EMR system addressed these issues by displaying a patient census and other information to users before they logged in. Administrators would construct these censuses so they did not display patient-identifying information. The pre-login window also displayed an onscreen list for selecting additional censuses to view, the names of attending providers for patients in the census that had new results, and a report (specified in the census definition) that displayed patient-specific data for a patient selected from the census.

This early solution, while superior to previous methods, still did not address certain needs. Instead of using a standard patient summary report for the pre-login window, administrators had to create a second report that did not include patient-identifying data, and assign it to the census. Members of patient treatment teams (other than the attending providers) still needed to log in to the system to see if patients for whom they were responsible had new results. There were no pre-login notifications for other data (for example, new nursing tasks) that might prompt a user to log in to the EMR system. Patient censuses displayed text only—unlike physical chart flags, the online census did not support easy-to-see indicators for tasks requiring attention.

### BRIEF DESCRIPTION OF THE DRAWINGS

FIG. 1 is a block diagram representing a data network adaptable for use with the method and system described below.

FIG. 2 is a block diagram representing a network computer used by the data network described in FIG. 1.

FIG. 3 is a block diagram depicting a health care facility network capable of adaptation for use with the method and system described below.

FIG. 4 is a schematic illustration representing a system graphical user interface.

FIG. 5 is a flow diagram illustrating some initial steps taken by the method and system to display patient information.

FIG. 6 is a flow diagram illustrating steps taken by the method and system to highlight displayed information and accept user input.

FIG. 7 is a flow diagram illustrating methods and system facilities for data refresh, user log in, and user exit.

FIG. 8 is a flow diagram indicates steps taken by the method and system to display patient information in a context-sensitive manner.

FIG. 9 is a flow diagram representing steps taken by the method and system to display online information resources incorporated in reports generated by an embodiment.

### DETAILED DESCRIPTION

The method and system described in this patent consolidate information from several sources within a hospital electronic medical record system, constructing a unified display. This display appears on public hospital computers accessible without the need to log in to the system. This pre-log-in window informs users when information in a patient record requires review. Thus, users know when to access the EMR for additional information, and what information to access and consult after logging in.

The system display may include: an electronic patient list, or census, with the ability to select and view the census for various treatment units; graphical alerts in the census display which notify users of new or relevant information; a list of users who are responsible for patients requiring attention, and who should therefore log in and consult the EMR; a report viewer through which users can choose to view summary reports of patient data, or facility-defined online resources such as clinical references, schedules, or a departmental home page.

The pre-log-in window preserves patient confidentiality by allowing administrators to categorize information and compose rules governing the display of each category. The system applies the rules without further user or administrator intervention, suppressing patient-identifiable or otherwise sensitive information when necessary. For example, the rules may restrict the information displayed by default on a terminal in a seating area, but allow more information to be displayed if a clinician logs on to the terminal. This system gives clinicians ready access to useful information such as patient room number, attending provider, and acuity level, without compromising security by displaying the patient's name or other personal information.

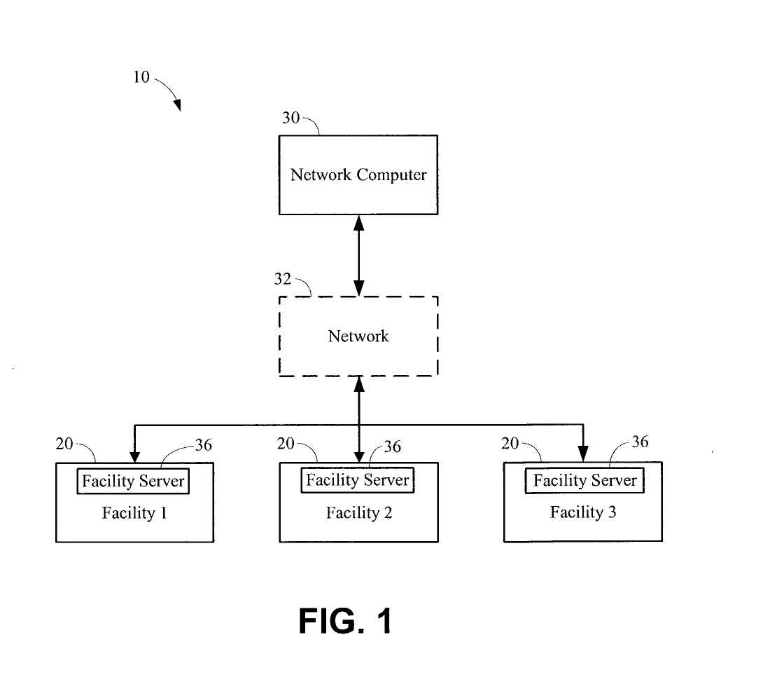

Various aspects of the method and system are depicted in FIGS. 1-9 and described below.

Data Network

FIG. 1 illustrates an embodiment of a data network 10 including a first group of healthcare facilities 20 operatively coupled to a network computer 30 via a network 32. The plurality of healthcare facilities 20 may be located, by way of example rather than limitation, in separate geographic locations from each other, in different areas of the same city, or in different states. The network 32 may be provided using a wide variety of techniques well known to those skilled in the art for the transfer of electronic data. For example, the network 32 may comprise dedicated access lines, plain ordinary telephone lines, satellite links, combinations of these, etc. Additionally, the network 32 may include a plurality of network computers or server computers (not shown), each of which may be operatively interconnected in a known manner. Where the network 32 comprises the Internet, data communication may take place over the network 32 via an Internet communication protocol.

The network computer 30 may be a server computer of the type commonly employed in networking solutions. The network computer 30 may be used to accumulate, analyze, and download data relating to a healthcare facility's medical records. For example, the network computer 30 may periodically receive data from each of the healthcare facilities 20 indicative of information pertaining to a patient's medical record, billing information, employee data, etc. The healthcare facilities 20 may include one or more facility servers 36 that may be utilized to store information for a plurality of patients/employees/accounts/etc. associated with each facility.

Although the data network 10 is shown to include one network computer 30 and three healthcare facilities 20, it should be understood that different numbers of computers and healthcare facilities may be utilized. For example, the network 32 may include a plurality of network computers 30 and dozens of healthcare facilities 20, all of which may be interconnected via the network 32. According to the disclosed example, this configuration may provide several advantages, such as, for example, enabling near real time uploads and downloads of information as well as periodic uploads and downloads of information. This provides for a primary backup of all the information generated in the process of updating and accumulating healthcare data.

Network Computer

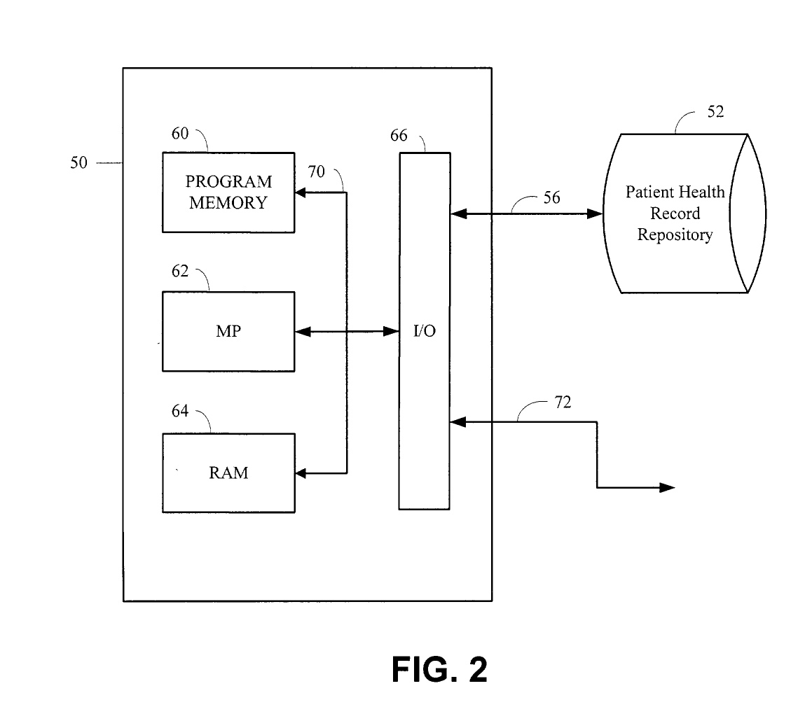

FIG. 2 is a schematic diagram of one possible embodiment of the network computer 30 shown in FIG. 1. The network computer 30 may have a controller 50 that is operatively connected to a database 52 via a link 56. It should be noted that, while not shown, additional databases may be linked to the controller 50 in a known manner.

The controller 50 may include a program memory 60, a microcontroller or a microprocessor (MP) 62, a random-access memory (RAM) 64, and an input/output (I/O) circuit 66, all of which may be interconnected via an address/data bus 70. It should be appreciated that although only one microprocessor 62 is shown, the controller 50 may include multiple microprocessors 62. Similarly, the memory of the controller 50 may include multiple RAMs 64 and multiple program memories 60. Although the I/O circuit 66 is shown as a single block, it should be appreciated that the I/O circuit 66 may include a number of different types of I/O circuits. The RAM(s) 64 and programs memories 60 may be implemented as semiconductor memories, magnetically readable memories, and/or optically readable memories, for example. The controller 50 may also be operatively connected to the network 32 via a link 72.

Facility Network

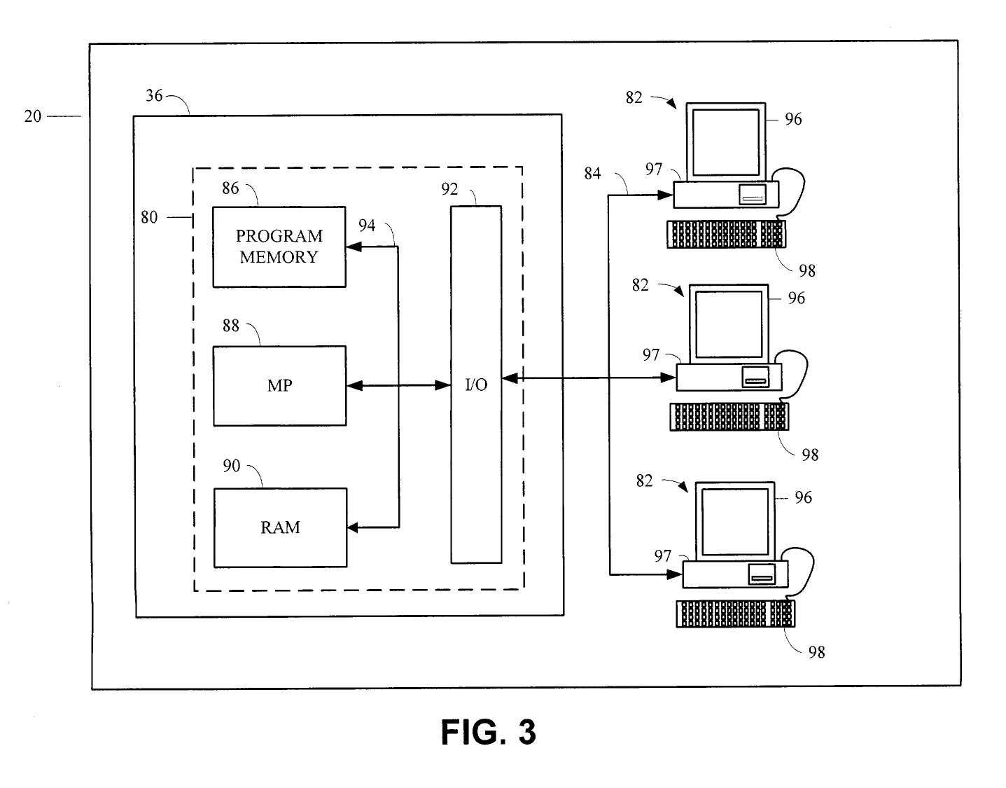

FIG. 3 is a schematic diagram of one possible embodiment of several components located in one or more of the healthcare facilities 20 from FIG. 1. Although the following description addresses the design of the healthcare facilities 20, it should be understood that the design of one or more of the healthcare facilities 20 may be different than the design of other healthcare facilities 20. Also, each healthcare facility 20 may have various different structures and methods of operation. It should also be understood that the embodiment shown in FIG. 3 illustrates some of the components and data connections present in a healthcare facility, however it does not illustrate all of the data connections present in a typical healthcare facility. For exemplary purposes, one design of a healthcare facility is described below, but it should be understood that numerous other designs may be utilized.

The healthcare facilities 20 may have a facility server 36, which includes a controller 80, wherein the facility server 36 is operatively connected to a plurality of client device terminals 82 via a network 84. The network 84 may be a wide area network (WAN), a local area network (LAN), or any other type of network readily known to those persons skilled in the art. The client device terminals 82 may also be operatively connected to the network computer 30 from FIG. 1 via the network 32.

Similar to the controller 50 from FIG. 2, the controller 80 may include a program memory 86, a microcontroller or a microprocessor (MP) 88, a random-access memory (RAM) 90, and an input/output (I/O) circuit 92, all of which may be interconnected via an address/data bus 94. As discussed with reference to the controller 50, it should be appreciated that although only one microprocessor 88 is shown, the controller 80 may include multiple microprocessors 88. Similarly, the memory of the controller 80 may include multiple RAMs 90 and multiple programs memories 86. Although the I/O circuit 92 is shown as a single block, the I/O circuit 92 may include a number of different types of I/O circuits. The RAM(s) 90 and programs memories 86 may also be implemented as semiconductor memories, magnetically readable memories, and/or optically readable memories, for example.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties. Healthcare employees may sign onto a client device terminal 82 using any generically available technique, such as entering a user name and password. If a healthcare employee is required to sign onto a client device terminal 82, this information may be passed via the link 84 to the facility server 36, so that the controller 80 will be able to identify which healthcare employees are signed onto the system and which client device terminals 82 the employees are signed onto. This may be useful in monitoring the healthcare employees' productivity.

Typically, facility servers 36 store a plurality of files, programs, and other data for use by the client device terminals 82 and the network computer 30. One facility server 36 may handle requests for data from a large number of client device terminals 82. Accordingly, each facility server 36 may typically comprise a high end computer with a large storage capacity, one or more fast microprocessors, and one or more high speed network connections. Conversely, relative to a typical facility server 36, each client device terminal 82 may typically include less storage capacity, a single microprocessor, and a single network connection.

### Overall Operation of the System

One manner in which an exemplary system may operate is described below in connection with a number of flow charts which represent portions or routines of one or more computer programs. These computer program portions may be stored in one or more of the memories in the controllers 50 and 80, and may be written at any high level language such as C, C#, C++, or the like, or any low-level, assembly or machine language. By storing the computer program portions therein, various portions of the memories are physically and/or structurally configured in accordance with the computer program instructions.

System Graphical User Interface

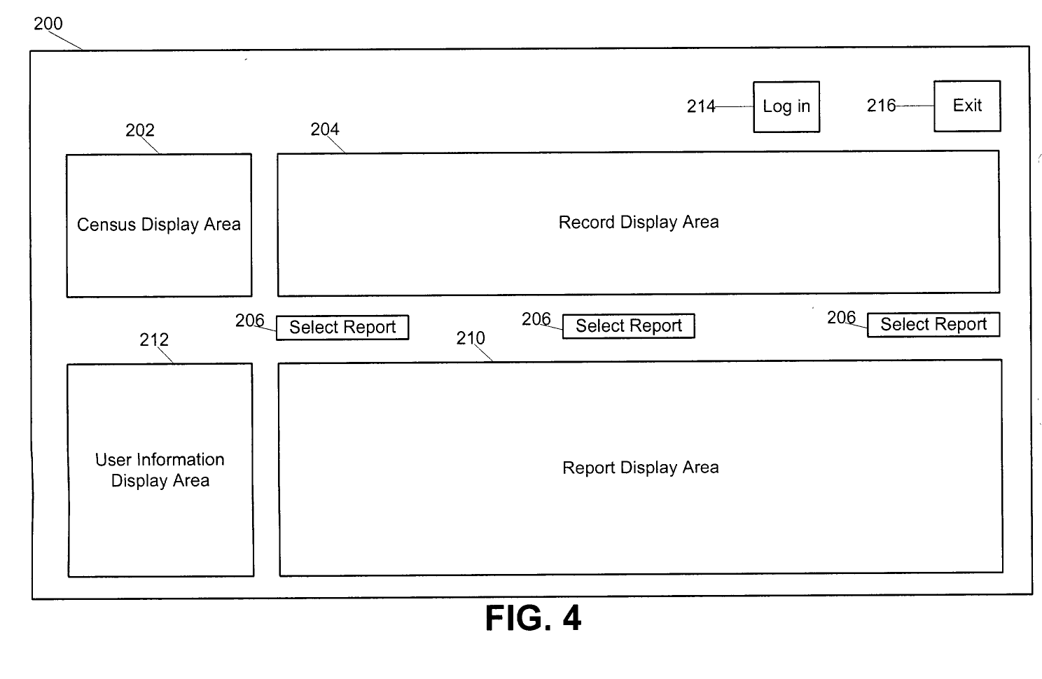

FIG. 4 represents a graphical user interface (GUI) 200 capable of displaying information to a user and receiving input from the user. The GUI 200 displays a census list 202. Each census available for inspection contains one or more records. The user may select a census from the census list 202, causing the system to display the records in the selected census within the record display area 204 of the GUI. The census whose records are displayed in the record display area 204 is referred to as the active census. As described below, one or more reports may be associated with a displayed record. In this case the user may view a report by pressing a GUI select report button 206. The selected report appears in the GUI report display area 210.

The system also determines which system users are impacted by displayed information, as described below. These users, known as the patient's treatment team, are notified of the relevant information when their identifying information is displayed by the GUI in the user information display area 212. The user may select an entry in the user information display area 212, affecting the information displayed in the record display area 204 and the report display area 210. The displayed information relevant to the selected user may be highlighted or otherwise emphasized; or the displayed information may be restricted to information relevant to the selected user.

The user may log in to the system by selecting the GUI log in button 214. This allows the user to obtain more detailed information from the system, possibly including sensitive or confidential information not displayed when a valid user is not logged in. The user may stop using the system by selecting the GUI exit button 216.

System Start, Census and Record Display

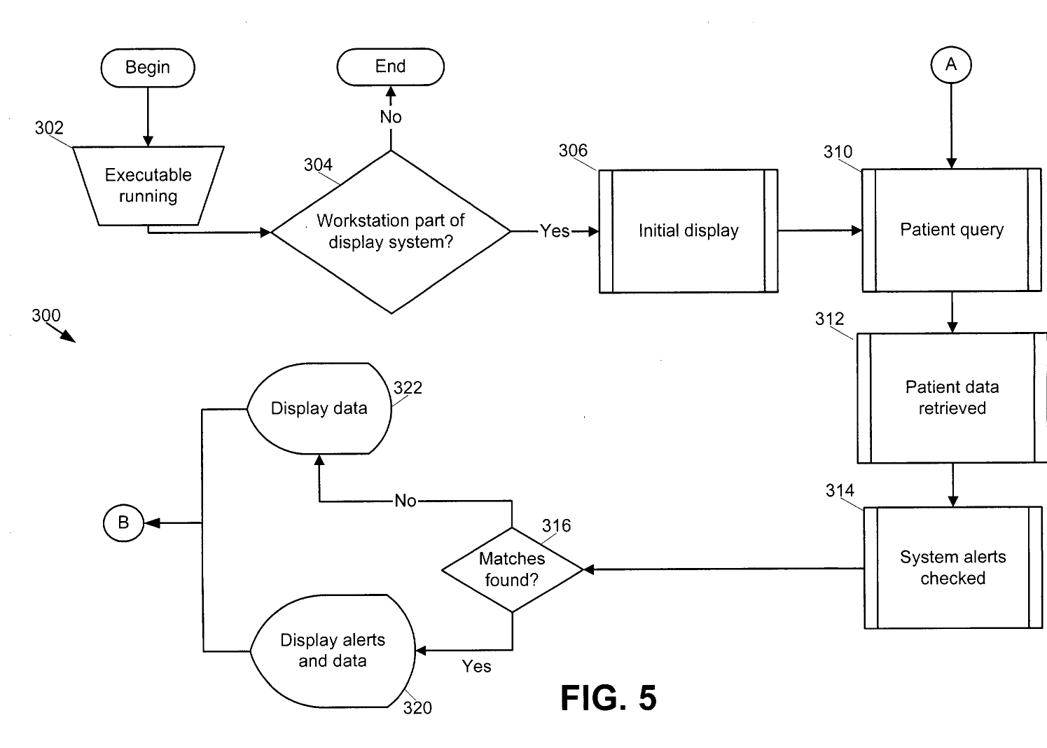

FIG. 5 illustrates a method 300 used by the system to construct the GUI display 200 examined above. Processing begins when a user executes 302 the system software on a workstation 82. The system software queries 304 a database of workstation records to determine whether the workstation 82 has a pre-log-in activity defined. If no pre-log-in activity is defined for the workstation 82, further processing by the system is not required, and the system awaits further action by the user.

If the workstation 82 has pre-log-in activities defined it constructs an initial display without immediate further user intervention. To begin this process, the system obtains a census list from the workstation record retrieved above (see block 304). The system initially displays 306 a first census in a census list. This requires information about patients whose records appear in the census, and all health care providers associated with each patient. The system queries one or more databases to obtain 310 the patient records. The system also obtains 312 information about relevant health care providers from this query.

Before displaying the information contained in the patient records, the system applies 314 rules to the information, determining whether any alerts should be indicated on the display 200. If the system determines 316 that alerts are required on the display 200, the system includes 320 textual or graphical alerts in the displayed information. These alerts may include colored, blinking or underlined text; alternate fonts; graphics such as pictures, borders or animations; or informative icons. If the system determines 316 that no alerts are required, the system simply displays 322 the patient records.

Report Display, Update Indicators, User Input

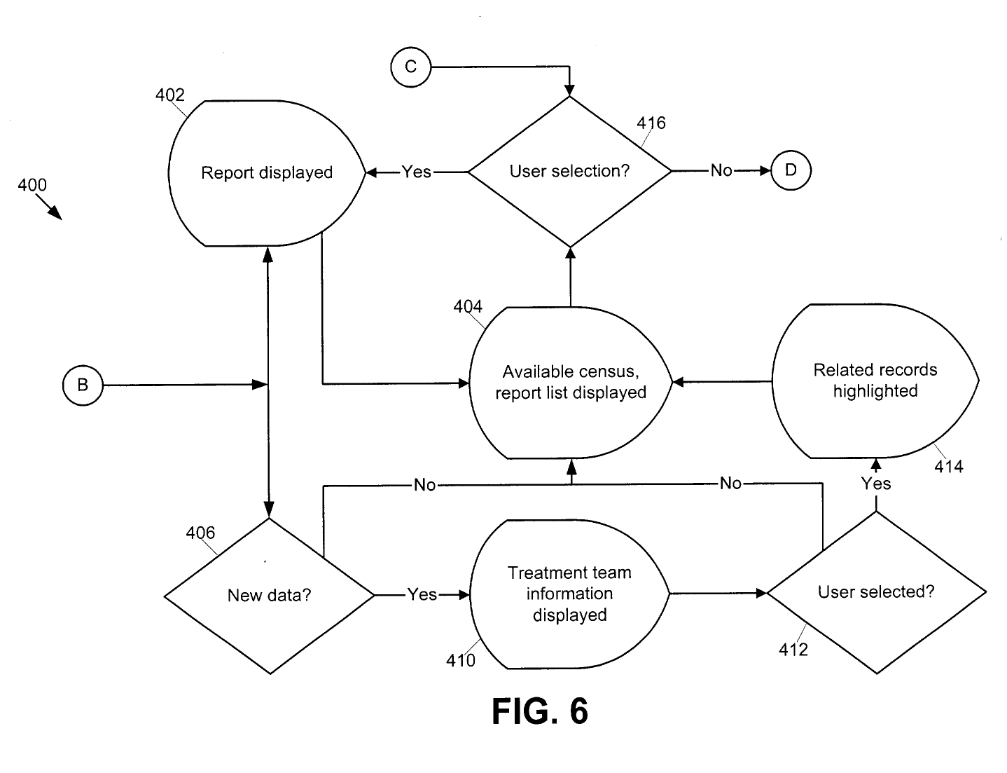

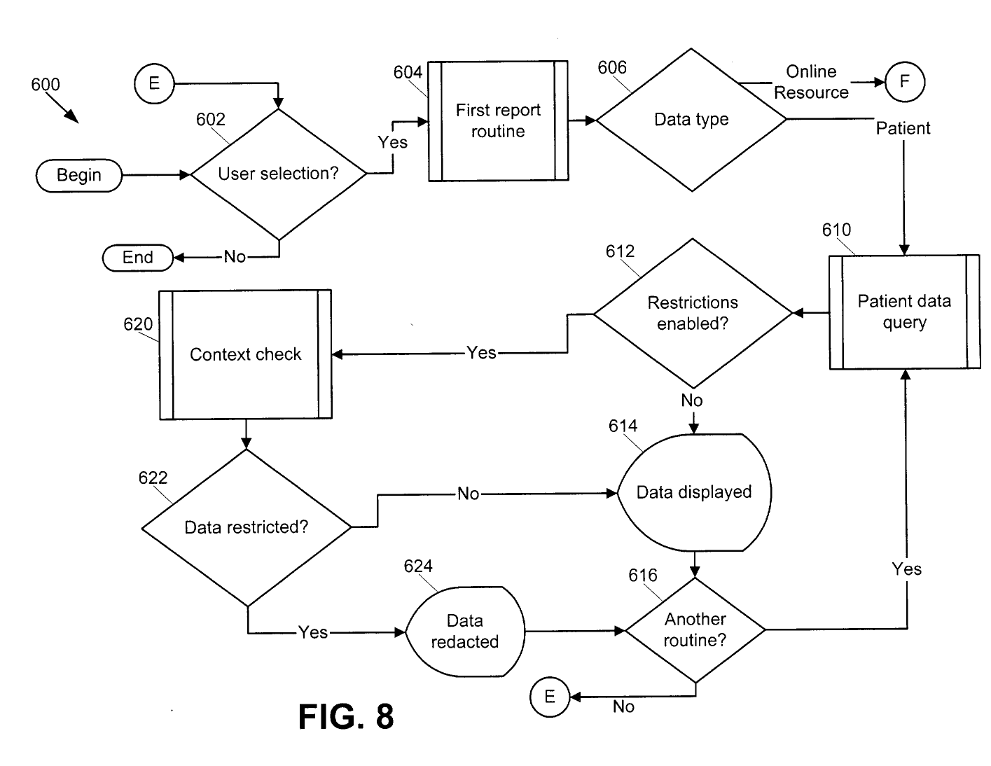

FIG. 6 illustrates further processing by the system 400. The display 200, depicted in FIG. 4, contains a report display area 210, containing 402 an online information resource or a report, corresponding to a record selected by the user, or to a default record, generated by the system as described below (see FIG. 8, block 600). The system also displays 404 a census list 202 and allows the user to select other reports 206 for viewing.

In addition, the system populates the user information display area 212, beginning by determining 406 which patients in the active census, if any, have new or updated information in their records. For each patient record with new or updated information, the system determines the identities of the treatment team, and displays 410 information about each member in the user information display area 212.

The user may select 412 a treatment team member from the user information display area 212. In this event the system responds by highlighting 414 records in the active census that contain new or updated information relevant to the selected treatment team member. The system continues to display 404 the census list and the available reports.

The system also allows the user to select 416 a record in the record display area 204, or a report indicated by a GUI select report button 206. When the user selects a record or report, the system modifies the display 200 to include the selected item, in a process similar to that used to populate 402 the display initially.

Display Refresh, User Exit and Log In

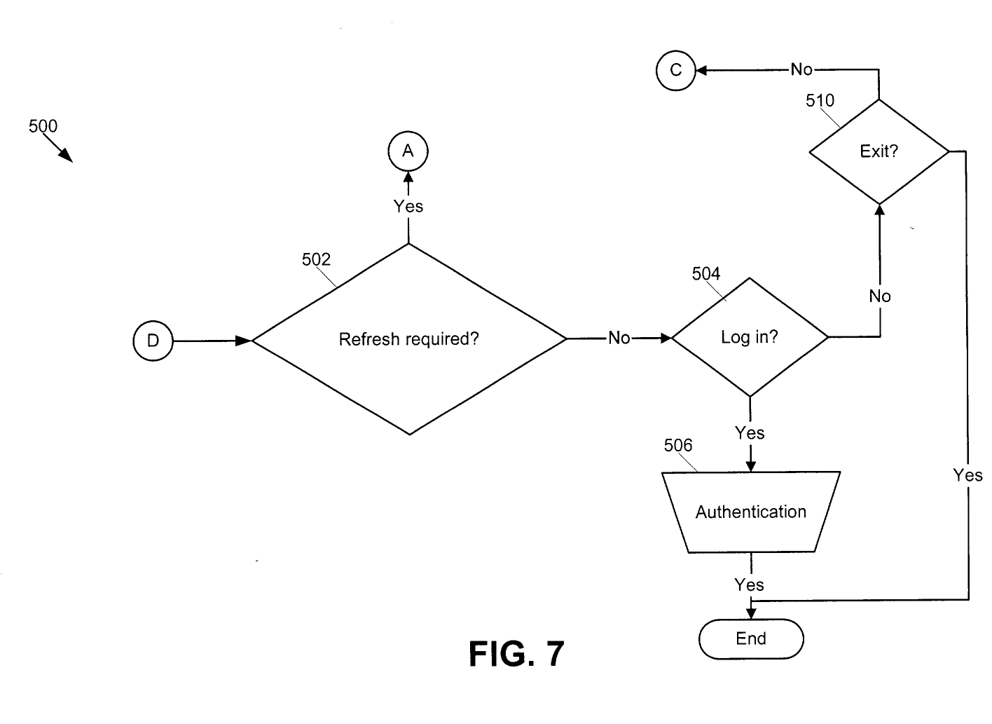

The user is permitted to select 416 a record or report, but user input is not required by the system. After a predetermined amount of time, the system may be required to refresh the displayed information, if system rules require such action. This aspect 500 of the system is illustrated in FIG. 7. If the selected census is displayed for more then a specified period of time, the system will refresh 502 the display automatically. This requires following steps described above (see FIG. 5 at block 310): patient and treatment team information is retrieved, alert and update rules are applied, and the display is constructed in the fashion illustrated in FIGS. 5-6. Similar steps are taken if the user refreshes the display manually, if such functionality is provided by an implementation of the system. This functionality is useful if the user wishes to check for new or updated data. Finally, these steps 310 are taken if the user chooses a census other than the active census for display by the system.

While the system waits for the user to select 416 a record or report, or select a census 502 for display; or for the refresh interval to expire 502, it also checks 504 for a user log in. The log-in process begins when the user presses the GUI log in button 214 (see FIG. 4), or provides appropriate input some other way, for instance by pressing a designated keyboard key or combination of keys. To successfully log in the user must authenticate 506 his or her identity, using the mechanism provided by the system, for example, by providing a username and password. While a user remains logged in, the system employs different rules when displaying records and constructing reports (see FIG. 8, block 616, 620).

The user may choose 510 to exit the system instead of electing 416 to view a record or report, or selecting 502 a census to view. Exiting the system halts further processing until the system is restarted 302 (see FIG. 5). The system waits until the user makes 416 a selection, the display requires 502 refreshing, a user logs in 504, or the user exits 510.

Patient Record Display

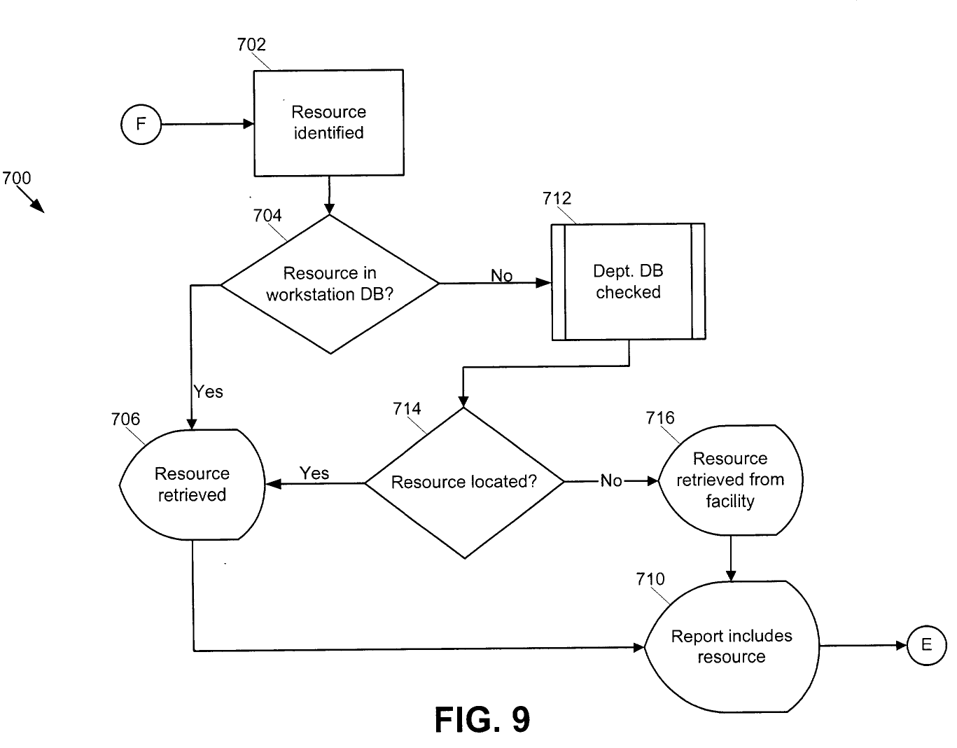

As described above, the system allows a user to select 416 a patient record or report, causing the system to display 402 a report or an online information resource. FIG. 8 describes the process 600 of displaying a report based on the selected patient record. FIG. 9 describes the process 700 of displaying an online information resource.

The process 600 of displaying a report based on a selected patient record begins when a user selects 602 a record in the active census, or selects 602 a report, by pressing a GUI select report button 206 (see FIG. 4). The system begins to construct the report by retrieving 604 a routine from a database. One or more routines specify the steps taken by the system to construct the report. The system determines 606 whether the routine will display patient information or an online information resource (described below in FIG. 9). The system obtains the patient information required by the routine by querying 610 a database.

Once the required patient information has been retrieved by the system from a database, the system determines 612 whether a restricted view of the information has been enabled by system administrators. Enabling restricted views of patient information allows the system to chose how information is displayed based on external circumstances such as the state of the display, the privileges of the user, etc. If no restricted view is enabled, the system simply displays 614 all the retrieved information. The system then determines 616 whether additional routines define the report and require processing. Processing continues 610 in this fashion until all routines required for assembling the report have been processed.

If the system determines 612 that restricted views of patient information have been enabled, the system must decide if a restricted view is required. This requires applying 620 rules embodied in the routine and checking the context of the display. Checking the display context may take into account many features, as described above, such as the identity or privilege level of the user, the location of the display, or even the date or time of day.

If the context of the display indicates that a restricted view is appropriate, the system checks 622 the data retrieved 610 by the routine. If the data requires restricted display in the current context, the data is not displayed 624. This may happen if the data is confidential or sensitive for some other reason.

As described above, the system proceeds by determining 616 whether other routines associated with the selected record or report require processing. The processing described above 610 continues for each associated routine.

Online Information Resources Displayed

As described above, the system allows a user to select 416 a patient record or report, causing the system to display 402 a report or an online information resource. FIG. 9 describes the process 700 of displaying an online information resource in detail.

Method 700 is invoked when the routine associated with a record or report displayed 600 by the system indicates 702 an online information resource must be displayed. This resource may be specified by uniform resource locator (URL), or by any other known method.

Once the system has identified the resource, it determines 704 if the resource is in the workstation database. If so, the system simply retrieves 706 the resource by some known mechanism and includes 710 the resource in the report generated and displayed.

If the indicated resource is not found in the workstation database, the system searches 712 the database in the department where the display is located. If the resource is located, it is retrieved 706 and included 710 in the report, as described above. If the resource is not located at the department level, the system retrieves 716 the resource from the facility database, and incorporates 710 the resource in the report, as described above.

After the online resource is located and displayed in a report, the system awaits 602 user input to continue processing.

Rules Utilized by the Method and System

Rules governing the display of data by the method and system described above are created in advance by users or administrators and then applied independently by various portions of the system. These rules control how the system displays patient records (see FIG. 8 at block 620-24). The construction and display of summary reports are likewise guided by the system rules (see FIG. 8). System rules specify data ranges and determine when graphical alerts are required on the display (see FIG. 5 at block 314 and 316). When alerts are required, rules determine the members of the treatment team impacted by the alerts and control the highlighting of user and treatment team members on the display (see FIG. 5 at block 312; FIG. 6). The system may also apply rules when responding to user input or selections, or to external events such as the expiration of a time interval (see FIG. 7 at block 502).

Various Implementations and Platforms Possible

Although the method and system for displaying patient information in a health care facility, described above, is preferably implemented by software, it may be implemented by hardware, firmware, or by another similar mechanism, on any processor used by the healthcare facility. The system may utilize a standard desktop computer, or any other computer equipment, such as handheld, portable or embedded devices. Implementations utilizing various devices may require user interfaces different than that depicted in FIG. 4, but offering substantially similar functionality, and may incorporate input devices other than those associated with desktop computers. Furthermore, the method and system may be implemented in a standard multi-purpose CPU or on specifically designed hardware or firmware. When implemented in software, the routines may be stored in any computer readable media, including magnetic disk, laser disk, or other storage medium; or in computer or processor RAM or ROM. Likewise, the software may be delivered to a user or process control system via any delivery method presently available or developed in the future. These methods include computer readable disk or another transportable computer storage mechanism; and communication channels such as telephone lines, the Internet, or any other network connection.

We claim:

1. A method for displaying patient and administrative information in a health care environment, comprising:
identifying a plurality of records;
selecting a record to display from the plurality of records;
identifying a plurality of rules governing data display;
applying the identified rules governing data display to the selected record;
preparing to display processed information from the selected record in accordance with the rules governing data display; and
displaying the processed information in accordance with the rules governing data display.

2. The method of claim 1 wherein preparing to display the processed information in accordance with the rules governing data display further comprises selecting data for display from the selected record.

3. The method of claim 1 wherein preparing to display the processed information in accordance with the rules governing data display further comprises emphasizing displayed information.

4. The method of claim 1 wherein preparing to display the processed information in accordance with the rules governing data display further comprises
identifying a set of effected users;
identifying an individual effected user, from the set of effected users; and
displaying information about the effected user.

5. The method of claim 4 wherein identifying a set of effected users comprises identifying a set of users effected by a group of information sources comprising:
the identified plurality of records,
the displayed information, and
the emphasized information.

6. The method of claim 4 wherein identifying an individual effected user comprises identifying an individual user effected by a group of information sources comprising:
the identified plurality of records,
the displayed information, and
the emphasized information.

7. The method of claim 1 wherein preparing to display information in accordance with the rules governing data display further comprises preparing a report based on a record.

8. The method of claim 1 wherein applying the rules governing data display comprises checking for an authenticated user.

9. The method of claim 1 wherein applying the rules governing data display comprises checking the identity of an authenticated user.

10. The method of claim 1 wherein applying the rules governing data display comprises checking the privileges of an authenticated user.

11. The method of claim 1 wherein applying the rules governing data display comprises checking the location of the display.

12. The method of claim 1 wherein applying the rules governing data display comprises checking at least one of the date and time of day.

13. The method of claim 2 wherein selecting data to display from the chosen record comprises automatically redacting particular record fields based on the rules governing data display.

14. The method of claim 13 wherein particular record fields comprise those containing confidential information.

15. The method of claim 3 wherein emphasizing information in the displayed record data comprises displaying textual information.

16. The method of claim 3 wherein emphasizing information in the displayed record data comprises displaying graphical information.

17. The method of claim 7 wherein preparing a report based on a record further comprises:
selecting a plurality of records to display;
allowing a user to select a record, from the plurality of displayed records;
constructing a report based on the selected record and the rules governing data display; and
displaying the report.

18. The method of claim 17 wherein constructing a report further comprises utilizing external information resources.

19. The method of claim 18 further comprising locating external information resources.

20. The method of claim 19 wherein locating external information resources comprises searching the local network.

21. The method of claim 19 wherein locating external information resources comprises searching remote networks.

22. The method of claim 18 wherein external information resources further comprise documents indicated by URL.

23. A system for displaying patient and administrative information in a health care environment, having a processor, via an electronic network, the system comprising:
a memory;
a first software routine stored in the memory and adapted to be executed on the processor to execute the step of obtaining a plurality records;
a second software routine stored in the memory and adapted to be executed on the processor to execute the step of obtaining rules governing data display;
a third software routine stored in the memory and adapted to be executed on the processor to execute the step of applying the rules to the plurality of records in preparation for displaying information;
a fourth software routine stored in the memory and adapted to be executed on the processor to execute the step of displaying information; and
a fifth software routine stored in the memory and adapted to be executed on the processor to execute the step of allowing the user to select a displayed record.
